(19) United States
(12) Patent Application Publication
(10) Pub. No.: US 2016/0364140 A1
(43) Pub. Date: Dec. 15, 2016

(54) PROMPTED TOUCHSCREEN FOR TEACHING USER INPUT AND DATA ENTRY

(71) Applicants: Gary Shkedy, San Diego, CA (US); Jonathan Shkedy, San Diego, CA (US); Alon Shkedy, San Diego, CA (US)

(72) Inventors: Gary Shkedy, San Diego, CA (US); Jonathan Shkedy, San Diego, CA (US); Alon Shkedy, San Diego, CA (US)

(21) Appl. No.: 14/739,276

(22) Filed: Jun. 15, 2015

(51) Int. Cl. G06F 3/0489; G06F 3/02; G06T 3/40; G09B 19/00; G06T 13/80; G06F 3/0488; G06F 3/0484; G06F 3/01; G06F 3/041; G06T 11/00

(52) U.S. Cl. CPC G06F 3/04895; G06F 3/0412; G06F 3/02; G06T 3/40; G06T 11/001; G06T 13/80; G06F 3/04883; G06F 3/04886; G06F 3/04842; G06F 3/016; G09B 19/0053; G06T 2200/24

(57) ABSTRACT

A system for a prompted touchscreen user interface for data entry having a server and a client connected by a network, a display, one or more than one external device and one or more than one prompted keyboard, where the keyboard is a virtual touchscreen, physical or both virtual touchscreen and physical with only one active key available at a time. The server displays a keyboard for data input on the display. The client has a physical keyboard that is coupled to the displayed keyboard. To facilitate learning each letter of a word, a set of numbers or symbols are highlighted on the displayed keyboard and the physical keyboard. When the user completes entering all the data presented, a new word, number or symbol is taught.

### FIELD OF THE INVENTION

The present invention relates generally to computer aided teaching and touchscreen data entry, and more particularly to a prompted touchscreen user interface for data entry.

### BACKGROUND

Teaching children, especially special needs children to recognize objects and actions usually requires teaching them to type or write the actual word associated with that object (for example, showing them a picture of an apple and then they type the word “apple.”) Since many children have fine motor issues, it is easier for them to type than write and thus a keyboard becomes the preferred method of communication. Typically, the child would use the keyboard to type the word from memory or they would be prompted with the word and then type the word. Specifically the user/child would touch or tap the keys on a touchscreen or physical keyboard.

Over the years, there have numerous solutions to this problem. Some companies have created large letter physical keyboards or even colored keyboards where vowels and consonants are differently colored. Some have even created keyboards where the 3 rows or s standard QWERTY keyboard are colored differently.

Additionally, there are also keyboards that utilize a backlight technology to assist users see the keys of a keyboard in dimly lit environments. See U.S. Patents 20140218890, 201401689350, 20140160722 and 20120229389 to name a few.

There are also keyboards that adjust to the users gaze U.S. Patent 20140035818 and others such as U.S. Patent 20130016043 that allow the user to customize their keyboards be selecting a predefined set of keys usually for gaming.

Disadvantageously, these prior art keyboards provide no assistance to a child who is struggling to learn the words. They present a keyboard that is static irrespective of what word the user needs to type.

Therefore there is a need for system that provides a prompted touchscreen user interface for data entry, for example teaching a particular word.

### BRIEF DESCRIPTION OF THE DRAWINGS

These and other features, aspects and advantages of the present invention will become better understood with regard to the following description, appended claims, and accompanying figures where:

FIG. 1 is a diagram of a system for a prompted touchscreen user interface for data entry according to one embodiment;

FIG. 2 is a diagram of a sub-system of the system of FIG. 1;

FIG. 3 is a diagram of various modules useful for the system of FIG. 1;

FIG. 4 is a screenshot of an English language keyboard display showing a letter “A” highlighted as a prompt to a user;

FIG. 5 is a screenshot of the English language keyboard display showing a letter “L” highlighted as a prompt to the user;

FIG. 6 is a screenshot of a mathematical language keyboard display showing a letter “Σ” highlighted;

FIG. 7 is a screenshot of a foreign language keyboard display showing a letter “É” highlighted; and

FIG. 8 is a flowchart diagram of some steps of a method for using the system of FIG. 1.

### SUMMARY

In one aspect of the invention, a method includes the following steps: (i) selecting a word or number to be taught, (ii) sending the word or number to the interface display and (iii) sending the current position in the word or number, and (iv) changing the display to prompt the user with the next key to tap. At least the sending step is performed by computer software running on computer hardware.

In one object of the present invention to set forth a keyboard that prompts the user by dynamically changing the color of the next required key. In another aspect of the present invention the prompt is enhanced by making the next required key blink. Also, it is another object of the invention to render all the incorrect keys inoperable, so if the user taps an incorrect key there is no response to the input. Additionally, in yet another object of the invention the number pad can prompt to teach the user addition.

The system for a prompted touchscreen user interface for data entry comprises at least one server, one or more than one client communicatively coupled to the server by a network, a display, one or more than one external device, and one or more than one prompted keyboard, where the keyboard is a touchscreen user interface, a physical keyboard or both a touchscreen user interface and a physical keyboard with only one active key available at a time. The network is wired, wireless or both wired and wireless. The server is configured to transmit and receive instructions executable on the one or more than one client and data for a prompted touchscreen user interface for data entry, where the client comprises a prompting touchscreen user interface. The system receives a request through the network from the client and selects a word, number or symbol to be taught based on the user's selection on the client. The the system breaks the word, number or symbol down to individually displayable elements and transmits each element to the client one element at a time to be displayed to the user on the touchscreen user interface. The physical keyboard is attached to the client corresponding to the displayed touchscreen keyboard provided by the system. The user's results can be tracked, ranked or scored.

The server further comprises a communication unit, a processor set communicatively coupled to the communication unit, and an input/output interface communicatively coupled the communication unit and the processor set. The processor set is also communicatively coupled to a memory device and a persistent storage device. The memory device comprises a random access memory and a cache that are operably connected to each other. The persistent storage comprises machine readable instructions executable on the processor set to create, manage, and control system functions, and further comprises data used by the system. The data and machine readable instructions executable on the processor set are stored and accessed by the one or more than one external device.

The server also comprises a word establishment module operably coupled to the server comprising instructions executable on the server for determining a word, number or symbol to be transmitted to the client; a letter establishment module operably coupled to the server comprising instructions executable on the server for breaking the word, number or symbol into individual elements that can be transmitted to the client one at a time until the entire word, number or symbol is completed; a keyboard establishment module operably coupled to the server comprising instructions executable on the server for determining a keyboard or other data entry pattern to be used based on the word, number or symbol from the work establishment module; a validate key module operably coupled to the server comprising instructions executable on the server for determining if a user entered the correct letter, number or symbol on the client; a receive key module operably coupled to the server comprising instructions executable on the server for receiving the letter, number or symbol from the client; a keyboard display module operably coupled to the server comprising instructions executable on the server for displaying the keyboard or other data entry pattern determined by the keyboard establishment module on the client; and a word complete module operably coupled to the server comprising instructions executable on the server for determining if every letter, number or symbol established by the word establishment module has been entered at the client.

The one or more than one client further comprises a physical keyboard that is communicatively coupled a displayed touchscreen user interface keyboard on the one or more than one client. The physical keyboard and the displayed touchscreen user interface keyboard highlight corresponding letters, numbers and symbols as a prompt to a user. The highlight for the displayed keyboard is selected from the group consisting of blinking, changing color, changing the fill/background color, changing the size of the font, changing the size of the key, and animating the displayed key, which is selected from the group consisting of adding a backlight to the next key, changing the color of the backlight, changing the color of the backlight of the whole key, blinking the backlight of the letter, blinking the backlight of the whole key, and vibrating or moving the next key. Inactive keys produce no output and the displayed keyboard, the physical keyboard or both the displayed keyboard and the physical keyboard transmit a message to the user indicating an error has occurred if the user selects an incorrect key, an inactive key, or both an incorrect key and an inactive key. The server and the client can be the same device.

A method for a prompted touchscreen user interface for data entry comprising the steps of first determining words, numbers or symbols to be taught to a user. Next, determining a next letter, number or symbol that the user should enter. Then, determining a layout for a keyboard or number pad to be displayed. Next, displaying the keyboard on a client display. Then, highlighting the letter, number or symbol on the displayed keyboard and the physical keyboard. Next, receiving at the server a user entered key on the client. Then, determining if the user entered key was the correct key displayed and highlighted on the displayed keyboard and the physical keyboard. Next, determining if the user has correctly typed the entire word, number or symbol. Then, transmitting a new word, number or symbol to the client if the entire word, number or symbol has been entered in step h). Next, transmitting the next element in the word, number or symbol to the client until the word, number or symbol is completely entered by the user. Then, repeating all steps until data entry is complete.

These and other objects of the invention will be apparent to those skilled in the art from the following detailed description of the invention, the accompanying drawings and the appended claims.

### DETAILED DESCRIPTION

The present invention overcomes the limitations of the prior art by providing a prompted touchscreen user interface for data entry. The invention facilitates numerous users needs such as:)
1) Teaching recognition of nouns and simple numbers by showing the user a picture of the object and using a prompting keyboard to learn the answer.
2) Teaching basic and advanced arithmetic, where the user is prompted with the numbers in the answer.
3) Teaching calculus where the user is prompted by the various symbols needed to express the desired equation.
4) Teaching sign language where the user is prompted with a visual symbol corresponding to the next hand gesture.
5) Teaching correct grammatical structure of a sentence where the user is prompted with the next letter in the next word of the sentence.
6) Teaching a foreign language where the user is prompted with the next letter in the word in the desired language.

As can be appreciated, the invention is not limited to the above situations but can be used in various industrial and commercial applications as well. The system can be used for technical or technician training on equipment until a certain proficiency is achieved. Students and teachers can benefit from a training without being singled out in a classroom or requiring additional one on one time. The system can self teach a numerous number of skills and concepts that can be broken down to individually displayable elements.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Systems, methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as, a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code that can comprise one or more executable instructions for implementing the specified logical function(s). It should also be noted that, in some alternative implementations, the functions noted in the blocks can occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “Server” refers to one or more than one device with at least one processor configured to transmit, receive and store: instructions executable on the at least one processor; and data from either a local or remote computing device. In some instances the local computing device can also be the server.

Various embodiments provide a prompted touchscreen user interface for data entry. One embodiment of the present invention provides a system for a prompted touchscreen user interface for data entry. In another embodiment, there is provided a method for using the system. The system and method will now be disclosed in detail.

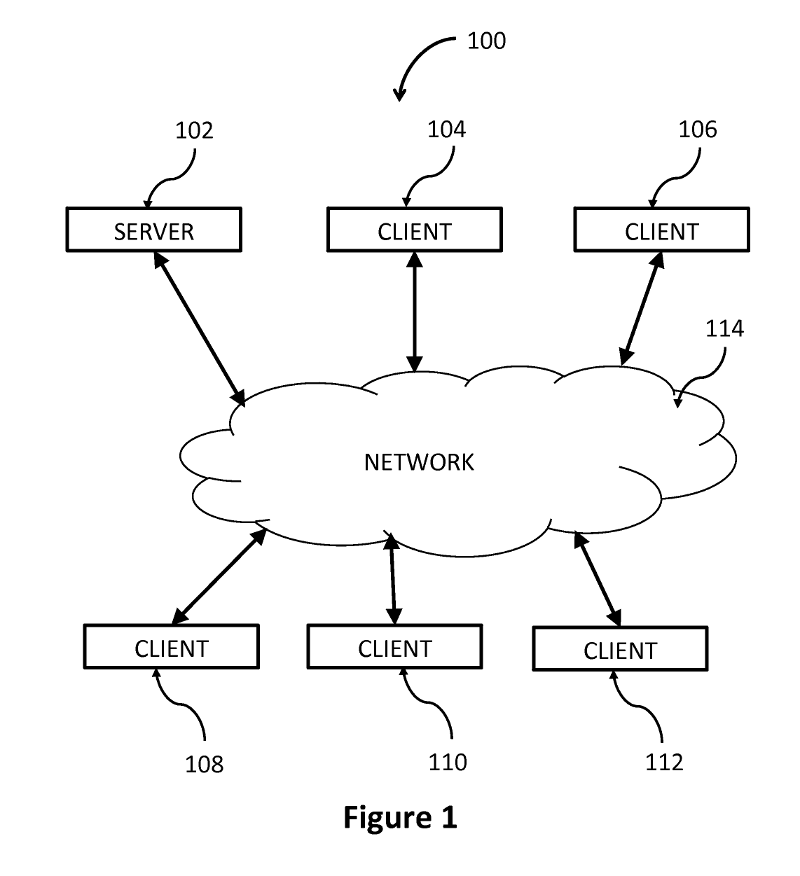

Referring now to FIG. 1, there is shown a diagram of a system 100 for a prompted touchscreen user interface for data entry according to one embodiment. As can be seen, the system 100 comprises at least on server 102 communicatively coupled to one or more than one client 104, 106, 108, 110 and 112. The at least one server 102 and the one or more than one client 104-112 are communicatively coupled to each other by a network 114. The network 114 can be wired, wireless or both wired and wireless. The server 102 transmits and receives instructions executable on the one or more than one client 104-112 and data for a prompted touchscreen user interface for data entry.

To explain more fully, a user accessing the client 104-112 is learning a new word. The system 100 uses the prompting touchscreen user interface of the client 104-112 to assist the user in learning the word. The system 100 will receive a request through network 114 from the client 104-112 and chooses a word, number or symbol based on the user's selection at the client 104-112. The system breaks the word, number or symbol down to individually displayable elements, such as, for example a letter, number or symbol, and transmits each element to the client 104-112 to be displayed for the user. The user will then enter the displayed element on a physical keyboard attached to the client 104-112 corresponding to the displayed keyboard provided by the system. Each of the elements are transmitted to the client 104-112 and displayed to the user after each successful data entry by the user. Optionally, the user's results can be tracked, ranked or scored.

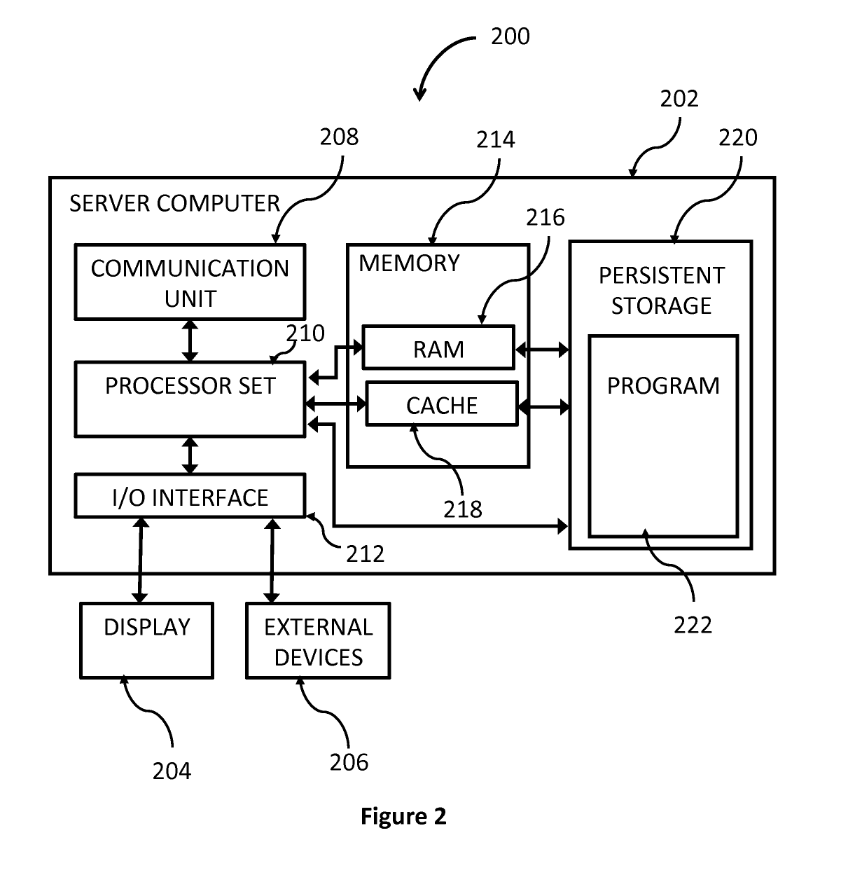

Referring now to FIG. 2, there is shown a diagram of a sub-system 200 of the system 100. As can be seen, the sub-system 200 comprises a server 202 that is operably connected to a display 204 and one or more than one external devices 206. The server 202 further comprises: a communication unit 208, a processor set 210 and an input/output interface 212 that, are, all communicatively coupled to each other. The processor set 210 is also communicatively coupled to a memory device 214 and a persistent storage device 220. The memory device 214 comprises a random access memory (RAM) 216 and a cache 218 that are operably connected to each other. The persistent storage 220 comprises machine readable instructions executable on the processor set 210 for the system 100 useful to create, manage, and control system 100 functions discussed below. The persistent storage 220 also comprises data used by the system 100 and the sub-system 200. Optionally, the data and machine readable instructions executable on the processor set 210 can be stored and accessed by the one or more than one external device. The display 204 is operable to display data to a user and may be, for example, a computer monitor, a tablet computer or a smart phone display screen or any other display means known in the art.

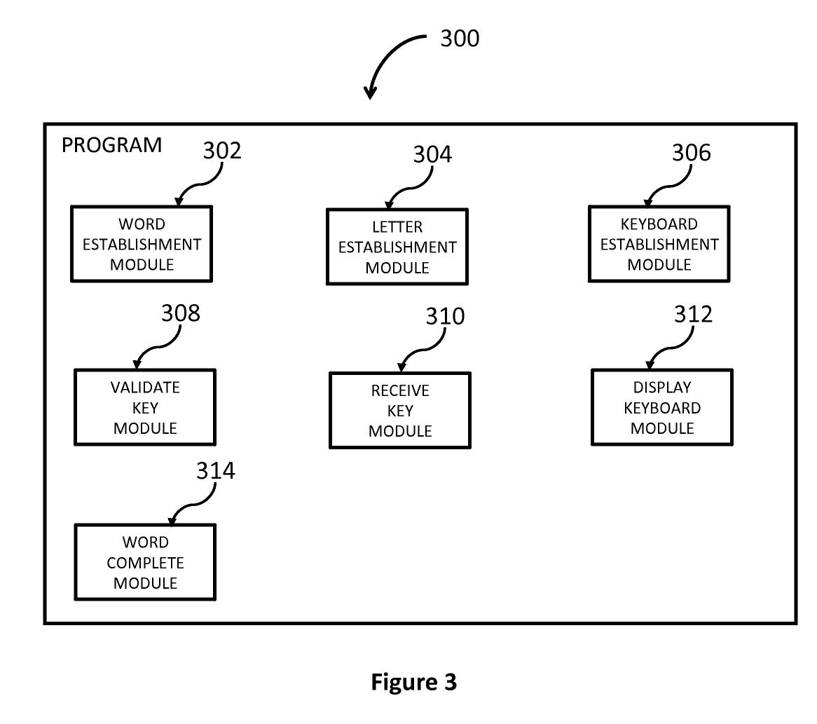

Referring now to FIG. 3, there is shown a diagram 300 of various modules, communicatively coupled to each other, useful for the system 100. A word establishment module 302 comprises instructions executable on the server 200 for determining a word, number or symbol to be transmitted to the client 104-112. A letter establishment module 304 comprises instructions executable on the server 200 for breaking the word, number or, symbol down to individual elements that can be transmitted to the client 104-112 one at a time until the entire word, number or symbol is completed. A keyboard establishment module 306 comprises instructions executable on the server 200 for determining a keyboard or other data entry pattern to be used based on the word, number or symbol from the work establishment module 302. A validate key module 308 comprises instructions executable on the server 200 for determining if a user entered the correct letter, number or symbol on the client 104-112. A receive key 310 comprises instructions executable on the server 200 for receiving the letter, number or symbol from the client 104-112. A keyboard display module 312 comprises instructions executable on the server 200 for displaying the keyboard or other data entry pattern determined by the keyboard establishment module 306 on the client 104-112. A word complete module 314 comprises instructions executable on the server 200 for determining if every letter, number or symbol established by the word establishment module 302 has been entered at the client 104-112.

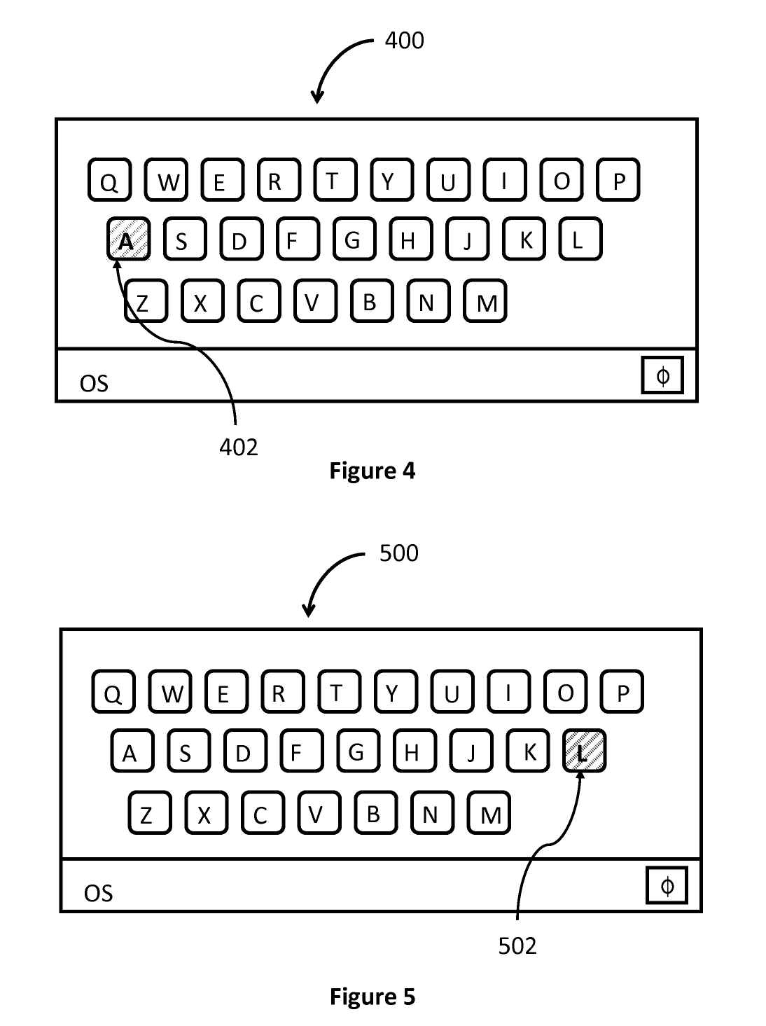

Referring now to FIG. 4, there is shown a screenshot of an English language keyboard display 400 showing a letter “A” highlighted 402 as a prompt to a user. The system 100 displays the letter “A” highlighted including prompt keyboard 402 so that the user will know what letter is in the word to be learned. Optionally, the letter “A” can be displayed blinking on the keyboard so that the user does not miss the letter. Those skilled in the art with reference to this disclosure will understand that there are many variations for drawing the user's attention to the letter, number or symbol displayed. The types of highlighting can consist of (i) changing the color of the letter, (ii) changing the color of the fill/background of the displayed key, (iii) applying a blinking to the display of the letter, (iv) applying a blinking to the display of the key fill/background (v) change the size of the font of the next letter (vi) change the size of the key, and (vii) animation added to the displayed key to attract attention (e.g. a continuous transition from a large to a small key) among other methods.

Additionally, a backlight of a physical keyboard can be controlled by the system 100 to highlight the letter “A”. The physical keyboard and the displayed keyboard will show the same letter to prompt the user. Highlighting the physical keyboard can be achieved by: (i) adding a backlight to the next key, (ii) changing the color of the backlight of the letter, (iii) changing the color of the backlight of the whole key (iv), blinking to the backlight of the letter, (v) blinking the backlight of the whole key, (vi) vibrating or moving the next key. Optionally, inactive keys, those keys that are not part of the work, number or symbol being taught, can be set to produce no output. Alternatively, if the user selects the incorrect key, or an inactive key, the display and/or the physical keyboard can transmit a message to the user indicating an error has occurred.

Referring now to FIG. 5, there is shown a screenshot 500 of the English language keyboard display 400 showing a letter “L” highlighted 502 as a prompt to the user. The system 100 displays a next letter in the word to be learned, “L”, and highlights, the letter on the display for the user and on the physical keyboard.

Referring now to FIG. 6, there is shown a screenshot of a symbolic mathematic keyboard display 600 showing a “Σ” highlighted 602. The system 100 can change the display of the keyboard on the client 104-112 to a non-standard keyboard. The system 100 can adapt the displayed keyboard to enter calculus equations or any other symbols, such as, for example sign language.

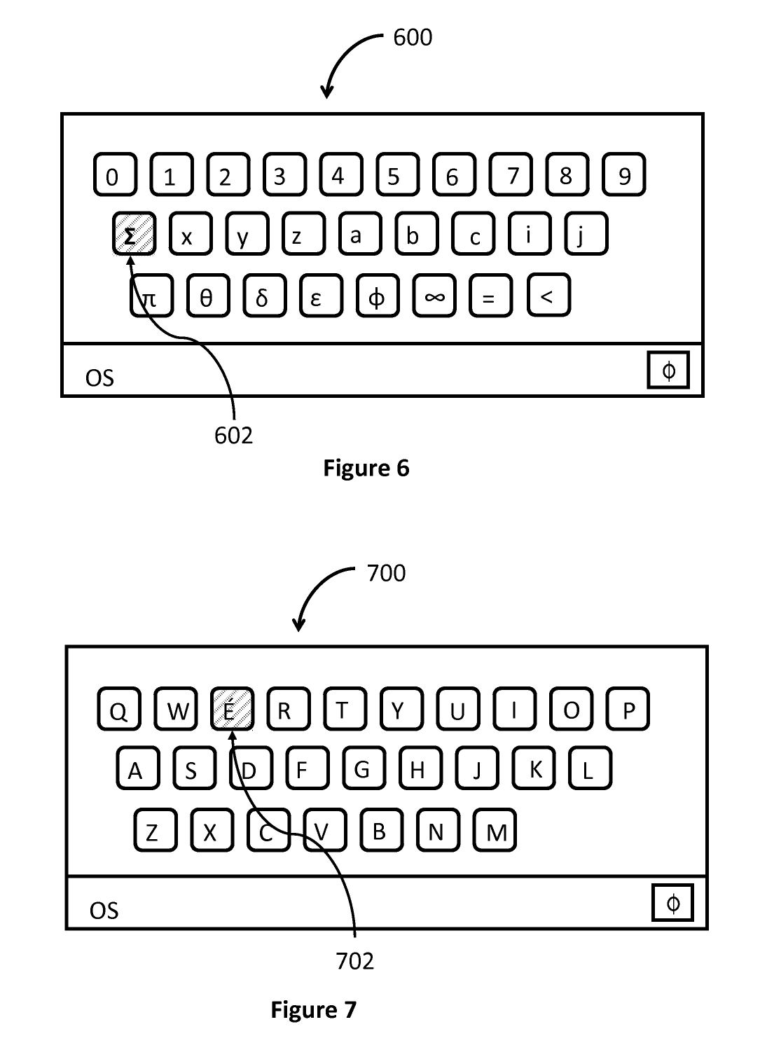

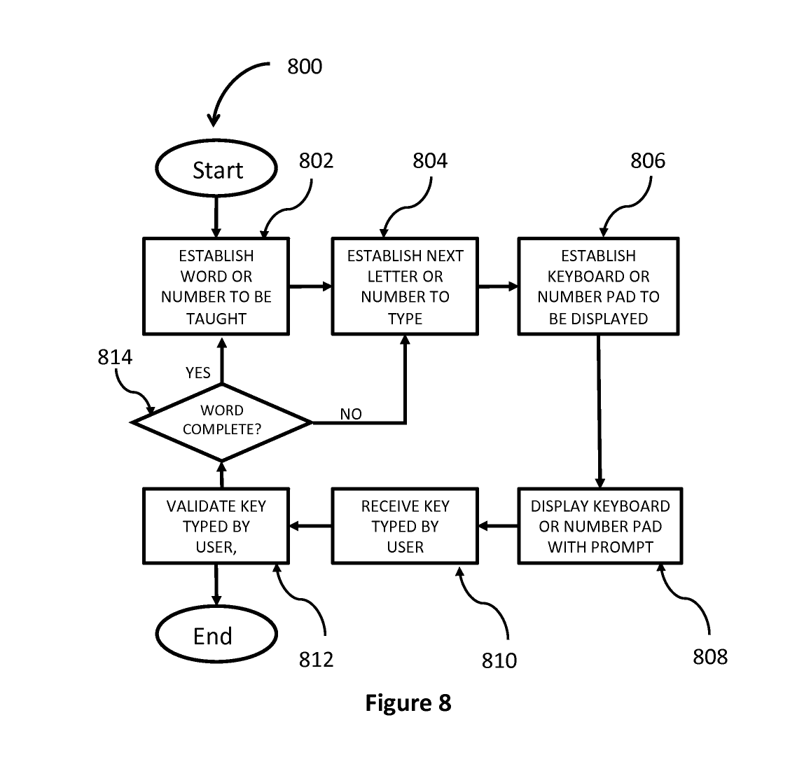

Referring now to FIG. 7, there is shown a screenshot 700 of a foreign language keyboard display showing a letter “É” highlighted 702. In this example, a physical foreign language keyboard comprising a backlight display will also illuminate the same key as the system 100 is displaying on the screen. As can be appreciated, the present invention spans languages and physical challenges of users of the system 100. As can also be appreciated, the server 200 can execute instructions and data for multiple clients 104-112 simultaneously in different languages or symbols providing a unique learning experience to each client 104-112 without the need to change either the server 200 or the client 104-112. This dual onscreen/physical keyboard combination re-enforces the learning without being draconian or too obtuse for the user to learn the words, numbers or symbols being taught enhancing the user's learning and retention.

Referring now to FIG. 8, there is shown a flowchart diagram 800 of some steps of a method for using the system of FIG. 1. First, an object establishment module determines a word or number to be taught 802 to a user. For example, the word can be nouns, verbs or basic integer numbers. Alternatively, the system 100 can display a sequence of letters, musical symbols, numbers and symbols, such as, for example, a sequence of sign language symbols or an algebraic equation with mathematical symbols to be taught. Then, the symbol establishment module determines a next letter, number or symbol 804 that the user should type. For example, the next letter would be the letter “a” if the noun was the selected word “apple,” after several iterations, the system could also display the letter “l” in the word “apple”. Next, a keyboard establishment module, determines a layout for a keyboard or number pad 806. Then, the system 100 highlights the letter “a” on the displayed keyboard and after several iterations or blinking the letter “a”, the next letter “l” is displayed highlighted on the keyboard. Next, the display keyboard module 312 displays a keyboard 808 on a client 104-112 display. Then, the receive key module 310 awaits for a user response from the client 104-112 and receives a key 810 entered by the user on the client 104-112. Next, the validate key module 308 and determines 812 if the user entered key was the correct key displayed. Then, the word complete module 314 determines 814 if the user has correctly typed the entire word, number or symbol. If yes, a new word, number or symbol is transmitted 802 to the client 104-112, otherwise, the next letter in the word, number or symbol is established 804 and transmitted to the client 104-112. The entire process can be repeated for a pre-determined number of iterations, or until the user exits the client 104-112, or any other number of repetitions that is known in the art.

What has been described is a new and improved system for a prompted touchscreen user interface for data entry, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps, are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A system for a prompted touchscreen user interface for data entry comprising:
a) at least one server;
b) one or more than one client communicatively coupled to the server by a network;
c) a display;
d) one or more than one external device; and
e) one or more than one prompted keyboard, where the keyboard is a touchscreen user interface, a physical keyboard or both a touchscreen user interface and a physical keyboard with only one active key available at a time.

2. The system of claim 1, where the network is wired, wireless or both wired and wireless.

3. The system of claim 1, where the server is configured to transmit and receive instructions executable on the one or more than one client and data for a prompted touchscreen user interface for data entry.

4. The system of claim 1, where the client comprises a prompting touchscreen user interface.

5. The system of claim 1, where the system receives a request through the network from the client and selects a word, number or symbol to be taught based on the user's selection on the client.

6. The system of claim 1, where the system breaks the word, number or symbol down to individually displayable elements and transmits each element to the client one element at a time to be displayed to the user on the touchscreen user interface.

7. The system of claim 1, where the physical keyboard is attached to the client corresponding to the displayed touchscreen keyboard provided by the system.

8. The system of claim 1, where the user's results can be tracked, ranked or scored.

9. The system of claim 1, where the server further comprises:
a) a communication unit;
b) a processor set communicatively coupled to the communication unit; and
c) an input/output interface communicatively coupled the communication unit and the processor set.

10. The system of claim 9, where the processor set is also communicatively coupled to a memory device and a persistent storage device.

11. The system of claim 10, where the memory device comprises a random access memory and a cache that are operably connected to each other.

12. The system of claim 11, where the persistent storage comprises machine readable instructions executable on the processor set to create, manage, and control system functions.

13. The system of claim 11, where the persistent storage further comprises data used by the system.

14. The system of claim 13, where the data and machine readable instructions executable on the processor set are stored and accessed by the one or more than one external device.

15. The system of claim 1, where the server further comprises:
a) a word establishment module operably coupled to the server comprising instructions executable on the server for determining a word, number or symbol to be transmitted to the client;
b) a letter establishment module operably coupled to the server comprising instructions executable on the server for breaking the word, number or symbol into individual elements that can be transmitted to the client one at a time until the entire word, number or symbol is completed;
c) a keyboard establishment module operably coupled to the server comprising instructions executable on the server for determining a keyboard or other data entry pattern to be used based on the word, number or symbol from the work establishment module;
d) a validate key module operably coupled to the server comprising instructions executable on the server for determining if a user entered the correct letter, number or symbol on the client;
e) a receive key module operably coupled to the server comprising instructions executable on the server for receiving the letter, number or symbol from the client;
a keyboard display module operably coupled to the server comprising instructions executable on the server for displaying the keyboard or other data entry pattern determined by the keyboard establishment module on the client; and
g) a word complete module operably coupled to the server comprising instructions executable on the server for determining if every letter, number or symbol established by the word establishment module has been entered at the client.

16. The system of claim 15, where the one or more than one client further comprises a physical keyboard that is communicatively coupled a displayed touchscreen user interface keyboard on the one or more than one client.

17. The system of claim 16, where the physical keyboard and the displayed touchscreen user interface keyboard highlight corresponding letters, numbers and symbols as a prompt to a user.

18. The system of claim 17, where the highlight for the displayed keyboard is selected from the group consisting of blinking, changing color, changing the fill/background color, changing the size of the font, changing the size of the key, and animating the displayed key.

19. The system of claim 17, where the highlight for the physical keyboard is selected from the group consisting of adding a backlight to the next key, changing the color of the backlight, changing the color of the backlight of the whole key, blinking the backlight of the letter, blinking the backlight of the whole key, and vibrating or moving the next key.

20. The system of claim 17, where inactive keys produce no output and the displayed keyboard, the physical keyboard or both the displayed keyboard and the physical keyboard transmit a message to the user indicating an error has occurred if the user selects an incorrect key, an inactive key, or both an incorrect key and an inactive key.

21. The system of claim 1, where the server and the client are the same device.

22. A method for a prompted touchscreen user interface for data entry comprising the steps of:
a) determining words, numbers or symbols to be taught to a user;
b) determining a next letter, number or symbol that the user should enter;
c) determining a layout for a keyboard or number pad to be displayed;
d) displaying the keyboard on a client display;
e) highlighting the letter, number or symbol on the displayed keyboard and the physical keyboard;
f) receiving at the server a user entered key on the client;
g) determining if the user entered key was the correct key displayed and highlighted on the displayed keyboard and the physical keyboard;
h) determining if the user has correctly typed the entire word, number or symbol;
i) transmitting a new word, number or symbol to the client if the entire word, number or symbol has been entered in step h);
j) transmitting the next element in the word, number or symbol to the client until the word, number or symbol is completely entered by the user;
k) repeating all steps until data entry is complete.
